(19) United States
(12) Patent Application Publication
(10) Pub. No.: US 2010/0194138 A1
(43) Pub. Date: Aug. 5, 2010

(54) SEALING ARRANGEMENT FOR A CABRIOLET VEHICLE

(75) Inventor: Peter Matthes, Leonard, MI (US)

Correspondence Address: FITCH, EVEN, TABIN & FLANNERY, P. O. BOX 18415, WASHINGTON, DC, 20036, US

(73) Assignee: WEBASTO AG, Stockdorf (DE)

(21) Appl. No.: 12/598,844

(22) PCT Filed: May 10, 2007
(86) PCT No.: PCT/EP2007/004165

§ 371 Date: Mar. 30, 2010

(51) Int. Cl. B60J 10/10

(52) U.S. Cl. 296/107.04

(57) ABSTRACT

The invention relates to a sealing arrangement for a convertible with a flexible top material for sealing off an outer top material region from a front edge region of a rear storage compartment cover when the top is closed, the sealing arrangement comprising a seal which is arranged between the top and the storage compartment cover and is kept in sealing contact by means of magnetic force.

The present invention relates to convertibles with a flexible top material (for example fabric top), and in particular to protection against undesirable penetration of water into an interior of a vehicle of this type.

In convertibles with a fixed top material, for example with a top formed from a plurality of movable roof panels (“retractable hardtop”), edge gaps present between mutually adjacent roof panels or between a roof panel and a body part when the top is closed are customarily sealed off from one another by an “edge gap seal” (for example made of flexible plastics material, such as, for example, an extruded rubber profile) being jammed between the vehicle components to be sealed off from one another.

However, in the case of the convertibles which are of interest within the context of the present invention and have a flexible top material, it is not possible in practice to correspondingly seal off the top from another (fixed or movable) vehicle component because an adequate sealing contact force between the flexible top material and the other vehicle component cannot be obtained by means of jamming.

In the case of known vehicles of this type, a “water management” system which is of greater or lesser complexity is always required because of said lack of sealability of the flexible top material. Generally, when the top is closed, water running down on the outer side of the top (for example rain water) is conducted in a targeted manner into a water collecting channel (not visible from the outside) or the like and is conducted further from there downward out of the vehicle body.

A water management system of this type is required in the case of known convertibles, in particular the transition between a rear region of the flexible top material and a front region of the vehicle rear. If the front region of the vehicle rear, which region is adjacent to the rear top region, is formed by a storage compartment cover (for example trunk cover or “tonnaeu cover”) which is operationally movable, there is also in practice a certain complexity for protecting against the penetration of water into the storage compartment in question.

It is an object of the present invention to provide a sealing arrangement for a convertible with a flexible top material, by means of which sealing arrangement an outer top material region can be sealed off from a front edge region of a rear storage compartment cover.

This object is achieved according to the invention by a sealing arrangement which has a seal which is arranged between the top and the storage compartment cover and is kept in sealing contact by means of magnetic force.

The basic concept of the invention is to seal off the gap which has hitherto not been sealed between the flexible top material and the front edge region of a rear storage compartment cover. The problem arising in this connection of said gap not being sealable with a conventional (jammed-in) seal is solved according to the invention by the use of magnetic force to provide a sealing contact force.

The invention is suitable for diverse convertibles and convertible tops, in particular, for example, for conventional folding tops, in which the flexible top material is stretched in the closed state of the top on a top linkage so as to cover a vehicle passenger compartment.

In one embodiment, it is provided that the entire top or at least the top material region to be sealed off from the storage compartment cover is formed from a textile fabric.

However, this is not intended to prevent the top in question from also having non-flexible top material regions.

In one embodiment, it is provided that the storage compartment which is covered by the storage compartment cover can be used as a trunk compartment or very generally as a loading compartment to be loaded by the user of the vehicle. As an alternative or in addition, the storage compartment can also be provided as a put-away compartment for the top (in the open state of the mop).

Irrespective of the design or the intended purpose of the storage compartment, it is provided, according to a preferred embodiment, that the storage compartment cover can be displaced upward and/or to the rear from the closed position thereof in order to open the storage compartment, for example for loading and unloading. In one embodiment in which the storage compartment serves as a put-away compartment for the top, it is provided that such a displacement for the opening up and closing of the put-away compartment takes place automatically in co-ordination with top opening and top closing operations which are preferably likewise automated.

In one embodiment, it is provided that the storage compartment cover is designed as a pivotable flap. A corresponding pivot axis can be provided here, for example, in a manner running in the transverse direction of the vehicle, in particular, for example, in the vicinity of a rear edge region of the flap.

A particular advantage of the sealing arrangement according to the invention is that the provision of a sealing contact force by means of magnetic force more likely sets low requirements with regard to the dimensional accuracy of the components to be sealed off from one another. The use of the magnetic force in conjunction with the flexibility of the top material (at least in the region of the gap to be sealed) surprisingly permits an “inherent compensation” of possible dimensional or positional tolerances of the components involved. Such tolerances may be present to a significant extent in particular for a storage compartment cover mounted movably on the vehicle body, for example articulated thereon in a pivotable manner. However, because of the abovementioned compensation for tolerances, this has virtually no effect in the design according to the invention on the sealing quality.

In one embodiment, it is provided that the lower side of the storage compartment cover has strip for forming a contact surface for the seal for the fastening of the seal.

A strip of this type is highly advantageous in particular if the front edge of the storage compartment cover runs approximately orthogonally or at least at a large angle with respect to a plane of the top material region (for example the top material region runs obliquely forward and upward and the storage compartment cover runs substantially horizontally). With a strip of this type, the sealing geometry can advantageously be adapted to the geometry of the components to be sealed off from one another.

Furthermore such a strip can also be provided with a mechanically stabilizing effect for the front edge region of the storage compartment cover.

Finally, a strip of this type made of magnetizable material (for example steel) can also advantageously be used in conjunction with the exertion of magnetic force, as can be understood, for example, from the exemplary embodiments described below.

The strip can be designed as an extension protruding downward as a single piece on the lower side of the storage compartment cover or else separately from a storage compartment cover body (for example in the form of a welded-on sheet metal elbow). A downwardly bent or angled front cover edge, for example, is also conceivable.

In a preferred embodiment, it is provided that the seal is designed as “magnetic seal”, i.e. as an elastic sealing body (for example made of foamed plastic) with permanently magnetic material integrated in the interior.

Magnetic seals are known per se, specifically for highly specific fields of use, such as the sealing off of a refrigerator door from the edge of the corresponding door opening, or the sealing off of a car door from the corresponding door opening.

As far as the design of the magnetic seal is concerned within the context of the present invention, recourse can advantageously be made to structures which are known per se. Reference is made in this respect to the following patent publications (and the prior art respectively cited therein) merely by way of example: U.S. Pat. No. 5,257,791; U.S. Pat. No. 5,367,831; U.S. Pat. No. 5,575,485; U.S. Pat. No. 6,273,433; and U.S. Pat. No. 6,655,698.

The permanently magnetic material which is integrated in a magnetic seal may be, for example, one or more “solid permanent magnets”. However the permanently magnetic material may also be formed, for example, from a multiplicity of relatively small magnetized particles arranged in a distributed manner (for example embedded in an elastic sealing material). In this case, in particular, a high degree of flexibility or curvability of the magnetic seal can be realized in a particularly simple manner. Within the context of the present invention, this has, for example, the logistical advantage that, in order to provide sealing arrangements on different types of vehicle, the same seal (running in a differently curved manner), for example a respective section of a extruded sealing profile, can be used.

However, it should also not be ruled out within the context of the present invention that, instead of the use of a magnetic seal, the magnetic force is produced by a magnet provided separately from the seal. In this context, the term “magnet” should be understood in very broad terms. It should include, for example, not only a “solid permanent magnet” but also, for example, a flexible permanently magnetic material (for example a plastics material with embedded magnetized particles).

In one embodiment, it is provided that magnetic material (in particular, for example, consisting of or containing a ferromagnetic metal, for example in the form of a steel band) or a permanently magnetic material is integrated (for example sewn) in a multilayered top material region or is fastened to the outer side of a top material region (for example sewn into a sealing material covering).

Therefore, materials serving to produce the sealing contact force by means of magnetic force can be fastened to the top in a simple and reliable manner.

Sewing to the top can also be used as an alternative or in addition to the fastening of elastic sealing material (for example a foamed plastic sealing profile, if appropriate with one or more hollow chambers and/or one or more sealing lips) to the outer side of the top. The sealing material fastened on the top may be, for example, part of a magnetic seal.

If a magnetic material is fastened to the top or to or in an elastic sealing material fastened to the top (for example a steel band sewn into or embedded in the sealing material), a permanent magnet arrangement (one or more individual magnets), for example, can be fastened in the front edge region of the storage compartment cover in order—when the top is closed—to “draw” the flexible top material “to the rear toward the cover edge region” by means of magnetic force.

Elastic sealing material can be fastened very generally to the outer side of the top and/or to the front edge region of the storage compartment cover.

In a preferred embodiment, it is provided that elastic sealing material is attached at least on the top (since typically used flexible top materials are generally not very suitable as a sealing contact surface). A sealing material attached (for example bonded and/or sewn) to the outer side of the top can come into contact, for example, directly with a sealing contact surface of the cover strip already mentioned above or a second sealing material (for example plugged-on sealing profile) fastened to said strip.

In one embodiment, it is provided that the seal extends in elongated form as a sealing strip in the transverse direction of the vehicle. In a development of said embodiment, it is provided that the seal, as viewed in the transverse direction of the vehicle, extends at least as far as lateral edges of the storage compartment cover. Therefore, for example, rainwater can be conducted laterally outward along the seal to a water outlet device (for example water channel) as is frequently provided in any case on both sides of the vehicle running in the longitudinal direction of the vehicle on both storage compartment cover edges.

It is very generally advantageous if, as viewed in the transverse direction of the vehicle, lateral ends of the seal are formed and/or arranged in such a manner that water can be transferred at said seal ends into a water outlet device on the vehicle body.

The invention is explained in more detail below using exemplary embodiments and with reference to the attached drawings, in which, in each case schematically:

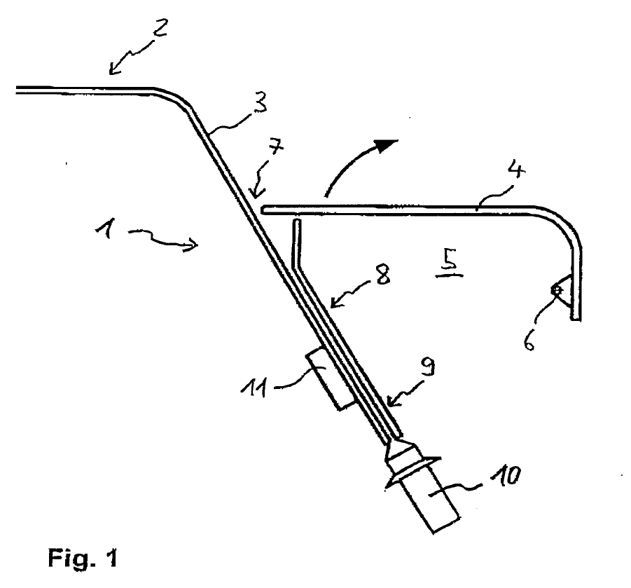

FIG. 1 shows a region of the transition from a top to a rear storage compartment cover of a convertible, in order to illustrate a conventional water management system in this region,

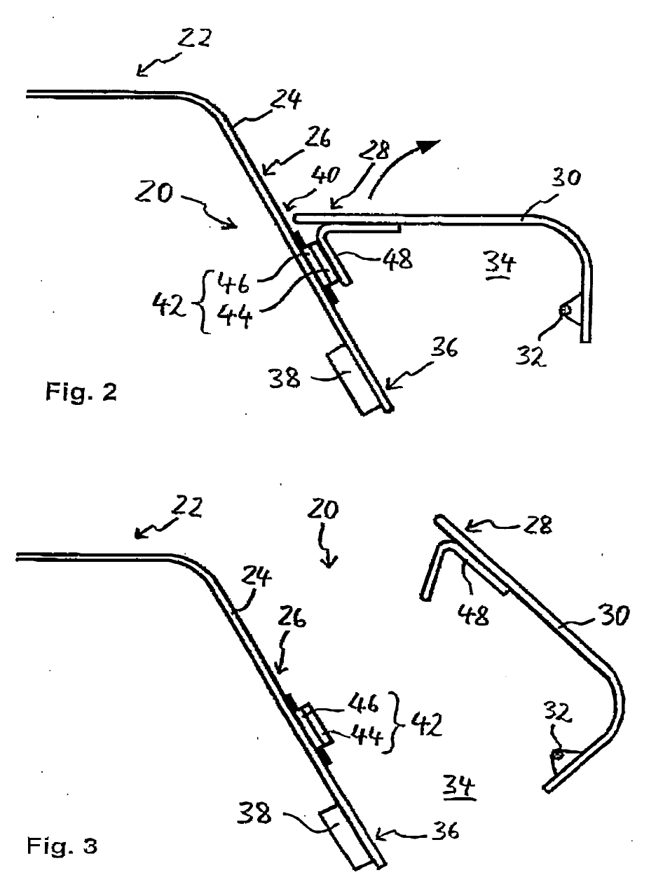

FIG. 2 shows a view corresponding to FIG. 1 according to an exemplary embodiment of a sealing arrangement, illustrated for a closed storage compartment cover,

FIG. 3 shows a view corresponding to FIG. 2, but illustrated with the storage compartment cover open,

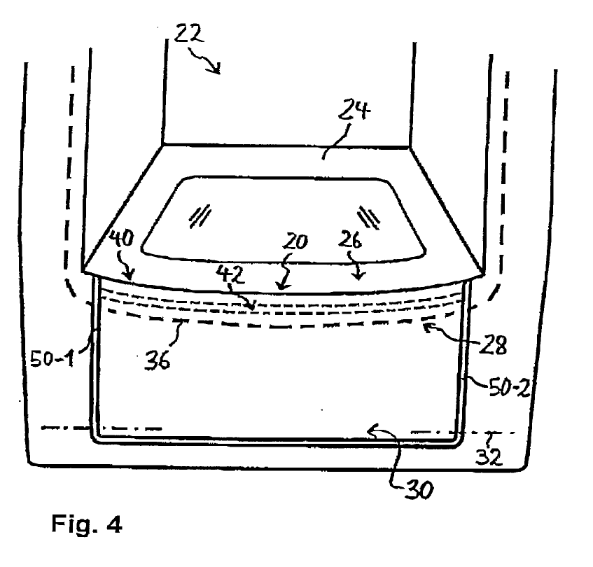

FIG. 4 show a top view of the sealing arrangement of FIGS. 2 and 3,

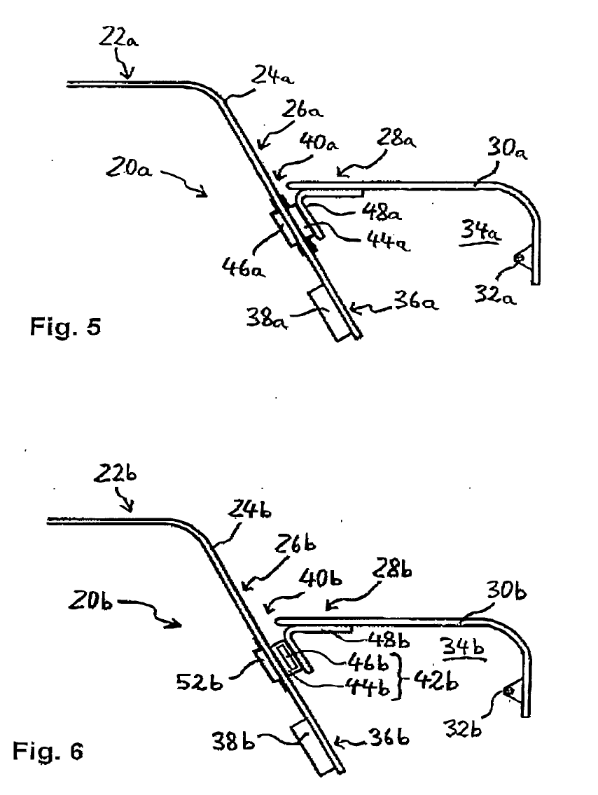

FIG. 5 shows a view corresponding to FIG. 2 for a further exemplary embodiment,

FIG. 6 shows a view corresponding to FIG. 2 for a further exemplary embodiment, and

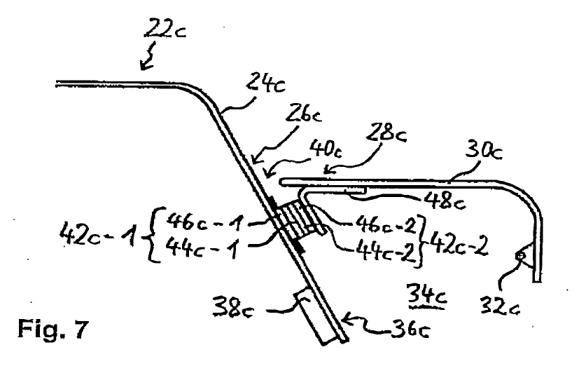

FIG. 7 shows a view corresponding to FIG. 2 for a further exemplary embodiment.

FIG. 1 shows a schematic side or longitudinal sectional view (not true to scale) of a water discharge arrangement 1 for a convertible (not illustrated in its entirety) with a fabric top 2.

Of the fabric top 2, only a textile top fabric 3 at the rear end of the top 2 is illustrated in FIG. 1 for the sake of simplicity. In the illustrated closed state of the top, the top fabric 3 is kept in the illustrated shape in a manner known per se by means of a top linkage (not illustrated) comprising a plurality of transverse bows. A strut 11 which runs in the transverse direction of the vehicle and is mounted on the vehicle serves for the fastening of the rear top edge.

To the rear, the top 2 is adjoined by a storage compartment cover 4 which forms a rear region of the vehicle in question, and, for example, upwardly bounds a storage compartment 5 for putting away the (open) top 2 at the rear. The storage compartment 5 is opened up for storing the top 2 by the storage compartment cover 4 pivoting about a pivot axis 6 running in the transverse direction of the vehicle.

In this structure, a gap 7 between the top fabric 3 and a front edge region of the rear storage compartment cover 4 is problematic.

Water running down on the outer side of the top 2 (for example rain water) has to be collected in a controlled manner by means of a comparatively complicated “water management” system (water discharge arrangement 1) and conducted out of the vehicle.

An essential component of the water discharge arrangement 1 is a watertight wall 8 which is arranged on (for example is sewn to) the outer side of the top fabric 3 below the storage compartment cover 4 and extends over substantially the entire width of the vehicle.

The combination of wall 8 and top fabric 3 opens downward at lateral edges of the top 2 into tube-like end sections 9 (“water bags”) which reach a long way downward and in which the water which penetrated via the gap 7 is collected. From there, the water is conducted on via water outlet connectors 10 which are inserted into the end sections 9 from below, and is conducted downwards out of the vehicle, for example in the region of lateral wheel guards of the vehicle (one of the two water outlet connectors 10 is illustrated in FIG. 1).

The provision of a water discharge arrangement of the type illustrated in FIG. 1 causes high material and manufacturing costs during the vehicle assembly.

Different variants of a concept by means of which a complicated water discharge arrangement of the above-described type is superfluous are described below with reference to FIGS. 2 to 7.

FIG. 2 is a schematic view corresponding to FIG. 1, of a rear region of a convertible and illustrates a sealing arrangement 20 for a convertible with a top 22 comprising a flexible top material 24 (for example textile top fabric) for sealing off an outer top material region 26 from a front edge region 28 of a rear storage compartment cover 30.

In the exemplary embodiment illustrated, the storage compartment cover 30 can be opened upward and to the rear (cf. the arrow in FIG. 2) by pivoting about a pivot axis 32 running in the transverse direction of the vehicle.

The storage compartment 34 located below the storage compartment cover 30 serves, for example, for the putting away of the top 22 in the open state and/or as a loading compartment (“trunk compartment”) to be loaded by a user of the vehicle.

A rear top fabric edge 36 is fixed by means of a fastening strut 38 running in the transverse direction of the vehicle.

In the structure illustrated, there is again a gap 40 between the top material region 26 and the front edge region 28 of the storage compartment cover 30. However water passing through said gap 40 is caught by means of a seal 42 which runs in a strip-shaped manner in the transverse direction of the vehicle, is arranged between the top 22 and the storage compartment cover 30 and is kept in sealing contact by means of magnetic force.

In the exemplary embodiment illustrated, the seal 42 is designed as a “magnetic seal”, i.e. in addition to an elastic sealing material region 44 (for example made of foamed plastic or “rubber sealing profile”) provided for the sealing contact, also has permanently magnetic material 46 which forms an integral part of the seal 42.

As symbolized in FIG. 2 the permanently magnetic material 46 can be a region (fox example permanent magnet strips) which is separate from the actual sealing material 44. As an alternative, the permanently magnetic material 46 could be present, for example, in the form of a multiplicity of magnetized particles embedded in distributed form in the sealing material 44.

The magnetic seal 42 can be formed, for example, substantially like a conventional magnetic seal on a refrigerator or freezer door.

The permanently magnetic material 46 interacts with a metallic strip 48, which is arranged on the lower side of the storage compartment cover 30, in such a manner that the elastic sealing material region 44 is jammed between the top 22 (more precisely: the permanently magnetic material 46) and the strip 48, which is designed as a sheet metal elbow, by means of the magnetic attraction force between the material 46 and the strip 48.

The strip 48 may be, for example, a spot-welded sheet metal elbow profile as is frequently used as such in any case for the mechanical stabilization of a storage compartment cover.

In other words, the seal 42 is kept in sealing contact (toward the strip 48) by means of a magnetic force. In this case, the magnetic force can be particularly advantageously oriented orthogonally with respect to the top material plane.

The assembly comprising the elastic sealing material 44 and permanently magnetic material 46 extends along the front edge of the storage compartment cover 30 in the transverse direction of the vehicle. This profile can be curved to a greater or lesser extent (in all directions in space) depending on the specific design of the vehicle. In this case, that surface of the strip 48 which is provided for contact with the elastic sealing material 44 has a correspondingly curved profile (to produce a continuous sealing line).

Water which has penetrated via the gap 40 is advantageously prevented from running on downward along the top material 24.

Since the sealing contact force required for the sealing action is realized by means of magnetic force, the flexibility or pliability of the top material 24 does not conflict with the intended sealing action. The flexibility of the top material 24 is even advantageous insofar as an inherent compensation of tolerances is provided therewith (relating to shape and positional tolerances of the top 22, on the one hand, and of the storage compartment cover 30, on the other hand).

FIG. 3 shows the situation after an opening pivoting of the storage compartment cover 30. When the cover 30 is opened (pivoted), the magnetic force caused by the permanently magnetic material 46 is overcome and the metallic strip 48 is detached from the corresponding sealing surface on the elastic sealing material 44.

In the described exemplary embodiment, the magnetic seal 42 is sewn on the outer side of the top 22 (in the vicinity of the metallic strip 48 when the top is closed).

FIG. 4 shows a top view of the rear region of the convertible in question.

It can be seen therefrom that the magnetic seal 42, as viewed in the transverse direction of the vehicle, extends as far as the lateral edges of the storage compartment cover 30. A respective water collecting channel 50-1 (on the left) and 50-2 (on the right), into which the water collected by the magnetic seal 42 and discharged laterally is transferred, is provided on the said lateral edges.

In the description below of further exemplary embodiments, the same reference numbers, in each case supplemented by a small letter to differentiate the embodiment, are used for components acting with identical effect. Only the differences with regard to the exemplary embodiment or the exemplary embodiments already described are discussed in this case and reference is furthermore hereby made expressly to the description of the previous exemplary embodiments.

The reference numbers of components which are provided repeatedly in an embodiment but are analogous in their effect are numbered consecutively (in each case supplemented by a hyphen and a continuing number). Reference is also made below by means of the non-supplemented reference number to individual components of this type or to the totality of components of this type.

FIG. 5 shows a sealing arrangement 20a in which, in contrast to the above-described embodiment, an elastic sealing material 44a and a permanently magnetic material 46a are not structurally combined in one “magnetic seal” but are arranged as separate functional regions. In the exemplary embodiment illustrated, the elastic sealing material 44a is fastened, for example sewn, to the outer side of a top 22a whereas the permanently magnetic material 46a is fastened, for example sewn, to the inner side of the top 22a (approximately congruently with the elastic sealing material 44a).

Also in this exemplary embodiment, the sealing material 44a is kept in sealing contact with an adjacent section when the top is closed (strip 48a of magnetic material, such as, for example, steel) by means of magnetic force.

FIG. 6 shows an exemplary embodiment of a sealing arrangement 20b in which a metallic band 52b is fastened to the inner side of a top 22b, and a magnetic seal 42b, consisting of elastic sealing material 44b with a permanently magnetic material 46b embedded therein, is fastened to a transversely extending strip 48b of a storage compartment cover 30b.

Also in this exemplary embodiment, a sealing material 44b is kept in sealing contact with an adjacent section (the top material region 26b of the top 22b) by means of magnetic force.

As an alternative, instead of the metallic band 52b, there could also be a band of permanently magnetic material, the direction of magnetization of which is selected such that there is an attracting magnetic force between the said magnetic material and the magnetic material 46b.

FIG. 7 shows an exemplary embodiment of a sealing arrangement 22c in which a first magnetic seal 42c-1 fastened on the top interacts with a second magnetic seal 42c-2 fastened on the cover in order to press respective elastic sealing materials 44c-1 (of the seal 42c-1 and 44c-2 (of the seal 42c-2) against each other. The respective permanently magnetic materials of the two magnetic seals 42c-1 and 42c-2 are referred to by 46c-1 and 46c-2.

A common feature of all of the above-described exemplary embodiments of sealing arrangements is that a force required for contact with an elastic sealing material when the top is closed is provided by a magnetic force. The above exemplary embodiments make it clear that, based on the said basic concept, highly diverse variant embodiments are possible. For example, an elastic sealing material can be fastened on the top or on the cover or both on the top and on the cover. A permanently magnetic material can likewise be fastened on the top or on the cover or both on the top and on the cover.

With a sealing arrangement of this type, a gap which was hitherto not sealed in known vehicles can advantageously be sealed, which is associated in practice with a considerable saving on costs.

### List of Reference Numbers

1 Water discharge arrangement

2 Top

3 Tap fabric

4 Storage compartment cover

5 Storage compartment

6 Pivot axis

7 Gap

8 Wall

9 End section

10 Water outlet connector

11 Fastening strut

20 Sealing arrangement

22 Top

24 Flexible top material

26 Top material region

28 Edge region of the storage compartment cover

30 Storage compartment cover

32 Pivot axis

34 Storage compartment

36 Top fabric edge

38 Fastening strut

40 Gap

42 Magnetic seal

44 Sealing material region

46 Permanently magnetic material

48 Strip

50 Water collecting channel

52 Metallic band

1. A sealing arrangement for a convertible with a flexible top material for sealing off an outer top material region from a front edge region of a rear storage compartment cover when the top is closed, said sealing arrangement comprising a seal which is arranged between the top and the storage compartment cover and is kept in sealing contact by means of magnetic force.

2. The sealing arrangement of claim 1, wherein the top material region is formed from a textile fabric.

3. The sealing arrangement of claim 1, wherein the storage compartment cover is provided for covering a rear storage space for the top.

4. The sealing arrangement of claim 1, wherein the lower side of the storage compartment cover has a strip for forming a contact surface for the seal or for the fastening of the seal.

5. The sealing arrangement of claim 1, wherein the seal is designed as a magnetic seal.

6. The sealing arrangement of claim 1, wherein a magnetic material or a permanently magnetic material is integrated in a multi-layered top material region or is fastened to the outer side of the top material region.

7. The sealing arrangement of claim 1, wherein the seal extends in elongated form as a sealing strip in the transverse direction of the vehicle.

8. The sealing arrangement of claim 7, wherein the seal as viewed in the transverse direction of the vehicle, extends at least as far as lateral edges of the storage compartment cover.

9. The sealing arrangement of claim 1, wherein, as viewed in the transverse direction of the vehicle, lateral ends of the seal are formed and/or arranged in a water outlet device in a vehicle body for the transfer of water.
